(19) United States
(12) Patent Application Publication
(10) Pub. No.: US 2005/0231309 A1
(43) Pub. Date: Oct. 20, 2005

(54) Board having magnetic members

(76) Inventor: Kun Ta Lee, Chong Ho City (TW)

Correspondence Address: Kun Ta Lee, P.O. Box 10-69, Chong Ho, Taipei, 235, TW

(21) Appl. No.: 10/826,845

(22) Filed: Apr. 15, 2004

(51) Int. Cl. H01H 51/22

(52) U.S. Cl. 335/78

(57) ABSTRACT

A board includes a number of cavities enclosed by a plate, to slidably receive a number of magnetic members, each of the magnetic members includes an outer end facing toward and movable toward the plate. A magnetic pen is movable on the board, to attract selected magnetic members toward the plate, and to have the outer ends of the selected magnetic members to be selectively seen through the plate. A liquid may be received in the cavities of the board to shield the magnetic members, and to prevent the magnetic members from being seen through the plate when the magnetic members are retracted into the cavities of the board.

### BACKGROUND OF THE INVENTION

1. Field of the Invention

The present invention relates to a board or a white board, and more particularly to a board or a white board having a number of magnetic members that may be caused to move by the other magnetic devices.

2. Description of the Prior Art

Typical black boards are required to be written or draft with chalks which may generate powders and may pollute our environment, and may hurt people, such as may hurt the lungs of people.

Typical white boards are required to be written or draft with ink pens which may include evaporate solutions that may also pollute our environment, and may be breathed by and may poison people.

The present invention has arisen to mitigate and/or obviate the afore-described disadvantages of the conventional boards.

### SUMMARY OF THE INVENTION

The primary objective of the present invention is to provide a board including a number of magnetic members that may be caused to move by the other magnetic devices or magnetic pens, for writing or drafting purposes.

The other objective of the present invention is to provide a board including a number of magnetic members that may be reusable without generating powders and evaporate solutions.

In accordance with one aspect of the invention, there is provided a board comprising a board body including a plurality of cavities formed therein, a plate attached onto the board body, to enclose the cavities of the board body, a plurality of magnetic members slidably received in the cavities of the board body respectively, and each including a first end facing toward and movable toward the plate, and a second end facing away from the plate, and a magnetic pen movable on the board body, to attract selected magnetic members toward the plate, and to have the first ends of the selected magnetic members to be selectively seen through the plate.

Each of the first ends of the magnetic members is applied with a color or a pattern thereon.

A liquid may further be provided and received in the cavities of the board body respectively, to shield the magnetic members, and to prevent the first ends of the magnetic members from being seen through the plate when the magnetic members are retracted into and received in the cavities of the board body respectively, and to allow the one ends of the magnetic members to be seen through the plate when the magnetic members are attracted toward the plate.

The magnetic members include a plurality of first magnetic members and a plurality of second magnetic members alternatively disposed in the cavities of the board body respectively. The first magnetic members and the second magnetic members include magnetic poles different from each other.

A retaining device may further be provided for retaining the magnetic members deeply in the cavities of the board body respectively, and the board body includes a plurality of orifices formed therein, the retaining device includes a plurality of magnetic elements slidably received in the orifices of the board body respectively, and actable with the magnetic members, to attract and to retain the magnetic members deeply in the cavities of the board body respectively. The board body includes a partition arranged between the orifices and the cavities thereof, to separate the orifices and the cavities thereof from each other.

A spring biasing device may further be provided for biasing the magnetic elements away from the magnetic members respectively, and includes a plurality of springs received in the orifices of the board body respectively, and engaged with the magnetic elements respectively, to bias the magnetic elements away from the magnetic members respectively. Each of the magnetic elements includes a shank extended therefrom, and the springs are engaged onto the shanks respectively.

The magnetic elements includes a plurality of first magnetic elements and a plurality of second magnetic elements alternatively disposed in the orifices of the board body respectively. The first magnetic elements and the second magnetic elements include magnetic poles different from each other.

The magnetic pen includes two ends each having a rounded surface formed thereon, to smoothly move on the plate, and to prevent the plate from being scraped by the magnetic pen. A magnetic eraser to attract the magnetic members toward the plate, or to repel the magnetic members away from the plate.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial plan view of a board in accordance with the present invention;

FIG. 2 is a cross sectional view of the board, taken along lines 2-2 of FIG. 1;

FIG. 3 is a plan schematic view illustrating the operation of the board;

FIG. 4 is a cross sectional view similar to FIG. 2, illustrating the operation of the board;

FIG. 5 is a plan schematic view illustrating the operation of the board as shown in FIG. 4;

FIG. 6 is a partial plan view similar to FIG. 1, illustrating the other arrangement of the board; and

FIG. 7 is a cross sectional view similar to FIG. 4, illustrating the operation of the board as shown in FIG. 6.

### DETAILED DESCRIPTION OF THE PREFERRED EMBODIMENT

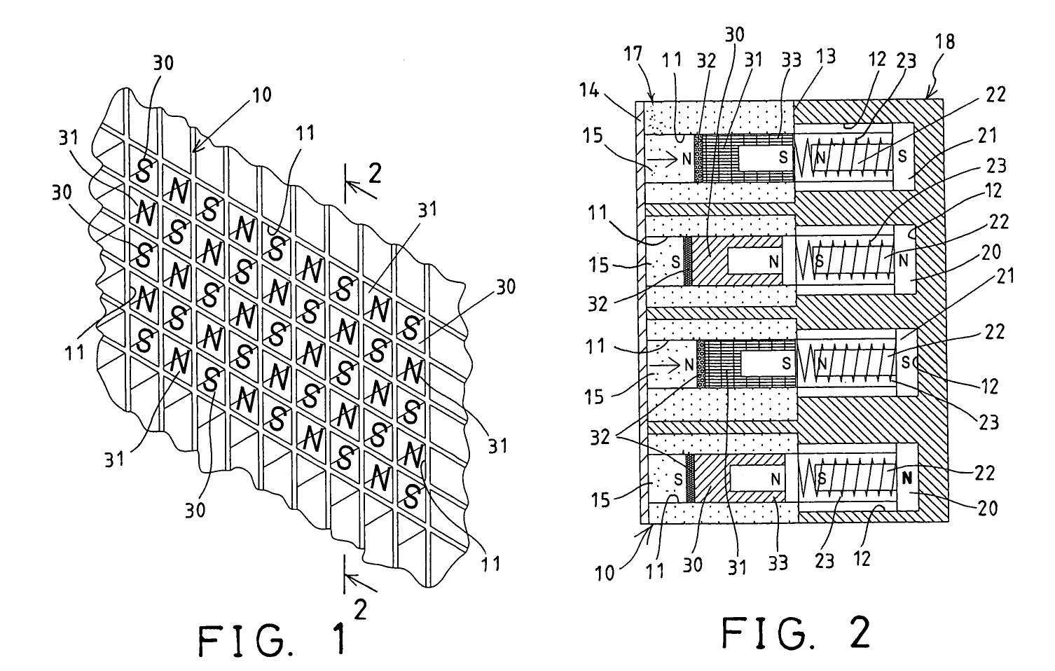

Referring to the drawings, and initially to FIGS. 1 and 2, a board in accordance with the present invention comprises a board body 10 including a number of cavities 11 formed in the upper portion 17 thereof, and a number of orifices 12 formed in the lower portion 18 thereof, and a partition 13 disposed in the middle portion of the board body 10, to separate the cavities 11 and the orifices 12 from each other.

A plate 14, such as a transparent or semi-transparent plate 14 is attached or secured on the upper portion 17 of the board body 10, and engaged onto the cavities 11 of the board body 10, to enclose or to seal the cavities 11 of the board body 10, and to allow the cavities 11 of the board body 10 to be formed as a water tight seal between the plate 14 and the partition 13.

A number of magnetic elements 20, 21 may be engaged in the orifices 12 of the board body 10 respectively, and alternatively disposed or arranged in the orifices 12 of the board body 10, and having magnetic poles different from or arranged opposite to that of the magnetic elements 21, 20 respectively. Each of the magnetic elements 20, 21 includes a shank 22 extended therefrom, and arranged to allow the magnetic elements 20, 21 to slide relative to the board body 10.

A number of spring members 23 are engaged onto the shank 22 of the magnetic elements 20, 21 respectively, and engaged with the partition 13, to bias or to move the magnetic elements 20, 21 away from the partition 13 (FIG. 2).

A number of further magnetic members 30, 31 may be disposed or engaged in the cavities 11 of the board body 10 respectively, and alternatively disposed in the cavities 11 of the board body 10, and having magnetic poles different from or arranged opposite to that of the magnetic members 31, 30 respectively, and each of the magnetic members 30, 31 includes one end 32 facing toward the plate 14, and the other end 33 facing toward the partition 13 and the other magnetic elements 20, 21 respectively.

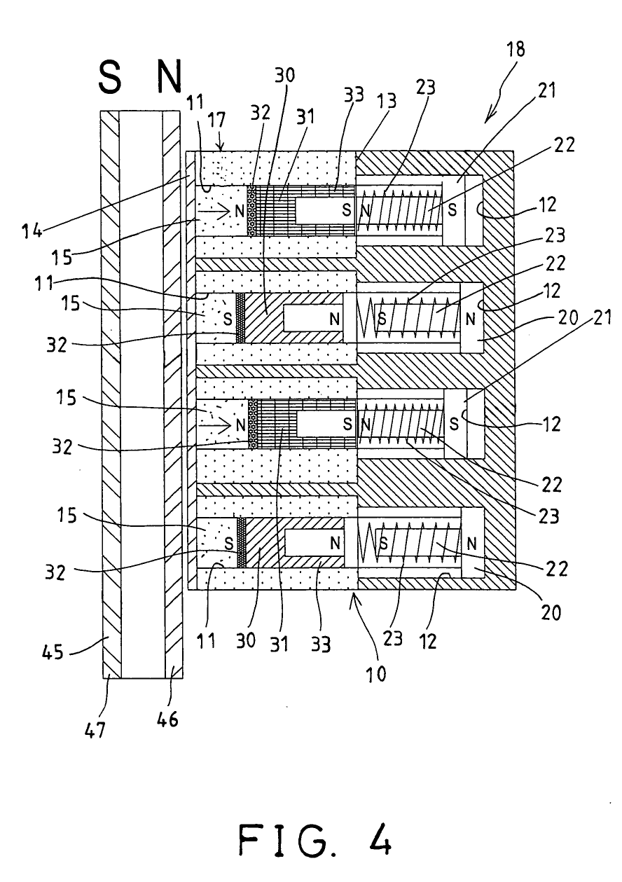

As shown in FIGS. 2 and 4, the magnetic poles of the other ends 33 of the magnetic members 30, 31 are arranged opposite to that of the other magnetic elements 20, 21, for allowing the magnetic members and the magnetic elements 20, 30; or 21, 31 to be attracted toward each other, and to retain the magnetic members 30, 31 deeply within the cavities 11 of the board body 10 respectively. The spring or resilient forces of the spring members 23 are arranged to allow the magnetic elements 20, 21 to be attracted and moved toward the other magnetic members 30, 31, against the spring members 23 when the magnetic members 30, 31 are moved toward the partition 13 and the magnetic elements 20, 21.

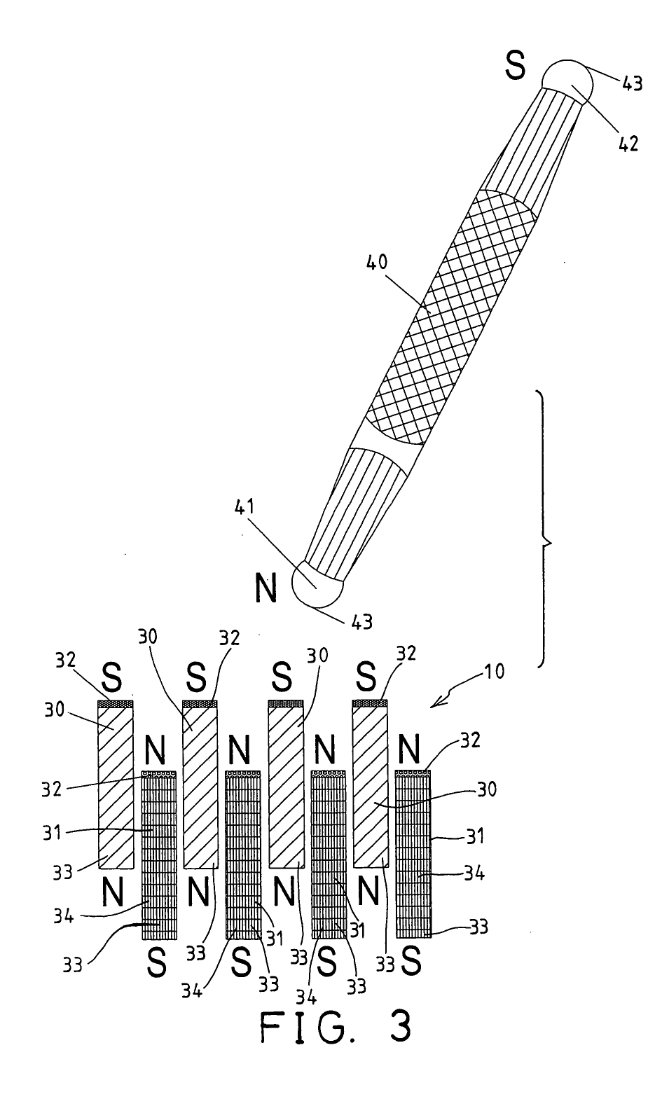

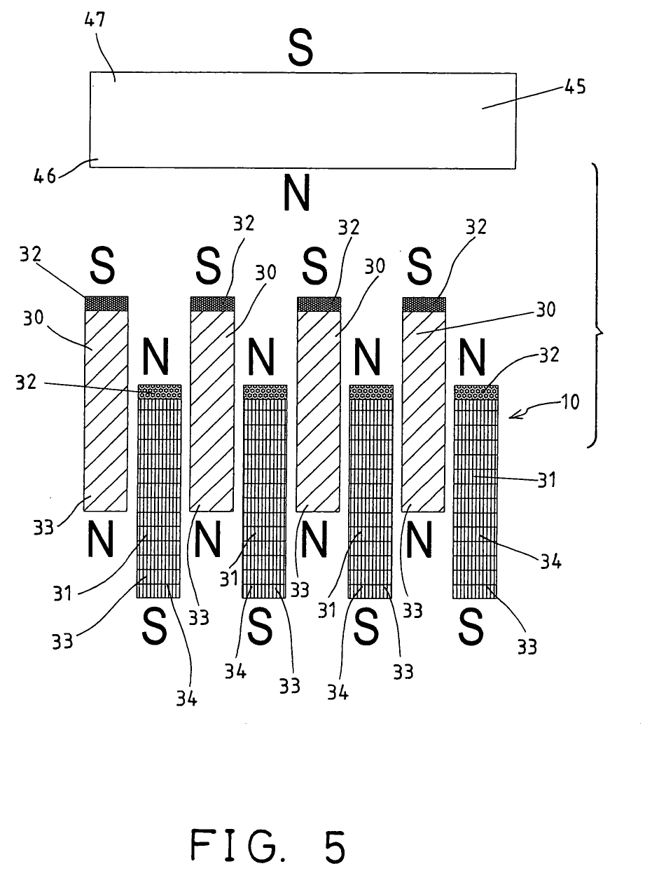

When the magnetic members 30, 31 are attracted or moved away from the partition 13 and the magnetic elements 20, 21 by such as magnetic pens 40 (FIG. 3), or magnetic eraser 45 (FIGS. 4, 5, 7), or the like, the spring members 23 may bias or move the magnetic elements 20, 21 away from the partition 13 and the magnetic members 30, 31 respectively, and thus to allow the magnetic members and the magnetic elements 20, 30; and 21, 31 to be moved away from each other. The magnetic members 30, 31 may each include one or more panels 34 secured together (FIGS. 3, 5).

As shown in FIG. 3, the magnetic pen 40 may include two ends 41, 42 of different magnetic poles, and each having a curved or rounded outer peripheral surface 43 formed thereon, for allowing the ends 41, 42 of the magnetic pen 40 to be smoothly moved on or relative to the plate 14, and for preventing the plate 14 from being scraped or damaged by the magnetic pen 40.

In operation, as shown in FIG. 3, when the end 41 of the magnetic pen 40 is moved toward or moved on the plate 14, the one ends 32 of the magnetic members 30 may be attracted toward the plate 14 and moved away from the magnetic elements 20, to allow the one ends 32 of the magnetic members 30 to be seen through the plate 14. It is preferable that the one ends 32 of the magnetic members 30 may be applied with various kinds of patterns or colors thereon, and to be seen through the plate 14 when the one ends 32 of the magnetic members 30 are attracted toward the plate 14.

On the contrary, due to the same magnetic poles on the one ends 32 of the other magnetic members 31 with the magnetic pole of the end 41 of the magnetic pen 40, the other magnetic members 31 may forced away from the plate 14, and may be attracted by and acted with the magnetic elements 21 (FIG. 4), to retract the other magnetic members 31 in the inner portions of the cavities 11 of the board body 10 respectively, and to prevent the one ends 32 of the magnetic members 31 from being seen through the plate 14.

Accordingly, when the magnetic pen 40 is moved or written or drafted on the plate 14, the selected magnetic members 30 may be attracted toward the plate 14, and arranged in response to or according to the handwriting or the trace of the magnetic pen 40, and to allow the one ends 32 of the selected magnetic members 30 to be seen through the plate 14.

After the writing operation with the magnetic pen 40, the magnetic eraser 45 may be arranged to have one of its sides 46 (N pole) located toward or close to the plate 14 (FIGS. 4, 5), to attract all of the magnetic members 30 toward the plate 14, and to allow the one ends 32 of all of the magnetic members 30 to be seen through the plate 14, and thus to remove the handwriting or the trace of the magnetic pen 40.

Alternatively, the magnetic eraser 45 may also be arranged to have the other side 47 (S pole) located toward or close to the plate 14 (FIGS. 4, 5), to repel the selected magnetic members 30 away from the plate 14, and to have the selected magnetic members 30 attracted by and acted with the magnetic elements 20, to retract the selected magnetic members 30 in the inner portions of the cavities 11 of the board body 10 respectively, and to prevent the one ends 32 of the selected magnetic members 30 from being seen through the plate 14, and thus to remove the handwriting or the trace of the magnetic pen 40.

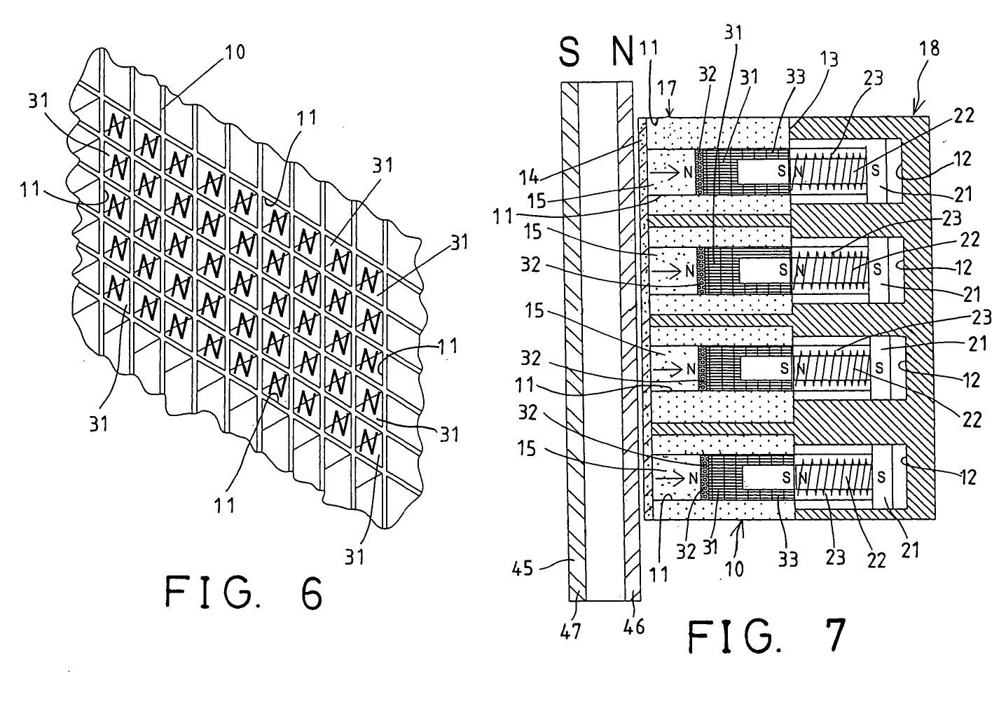

Alternatively, as shown in FIGS. 6 and 7, all of the cavities 11 of the board body 10 may arranged to have the magnetic members 31 engaged therein, instead of the magnetic members 30, 31 alternatively arranged therein. The moving or writing or drafting of the magnetic pen 40 on the plate 14 may also attract selected magnetic members 31 toward the plate 14, and arranged in response to or according to the handwriting or the trace of the magnetic pen 40, and to allow the one ends 32 of the selected magnetic members 31 to be seen through the plate 14.

The handwriting or the trace of the magnetic pen 40 may also be removed or erased by the magnetic eraser 45, by placing such as the one side 46 (N pole) of the magnetic eraser 45 toward or close to the plate 14, to repel the selected magnetic members 31 away from the plate 14, and to have the selected magnetic members 31 attracted by and acted with the magnetic elements 21, to retract the selected magnetic members 31 in the inner portions of the cavities 11 of the board body 10 respectively, and to prevent the one ends 32 of the selected magnetic members 30 from being seen through the plate 14, and thus to remove the handwriting or the trace of the magnetic pen 40.

As shown in FIGS. 2, 4, 7, it is preferable that a liquid 15, such as white liquid or the like, is received within the cavities 11 of the board body 10, to shield and to prevent the one ends 32 of the selected magnetic members 30 from being seen through the plate 14 when the magnetic members 30, 31 are retracted into the inner portions of the cavities 11 of the board body 10 respectively, and to allow the one ends 32 of the selected magnetic members 30 to be seen through the plate 14 when the magnetic members 30, 31 are attracted toward the plate 14.

It is to be noted that the board may be written or drafted again and again, without generating powders and evaporate solutions, and no pens or ink or chalks will be consumed.

Accordingly, the board in accordance with the present invention includes a number of magnetic members that may be caused to move by the other magnetic devices or magnetic pens, for writing or drafting purposes, and that may be reusable without generating powders and evaporate solutions.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A board comprising:
a board body including a plurality of cavities formed therein,
a plate attached onto said board body, to enclose said cavities of said board body,
a plurality of magnetic members slidably received in said cavities of said board body respectively, and each including a first end facing toward and movable toward said plate, and a second end facing away from said plate, and
a magnetic pen movable on said board body, to attract selected magnetic members toward said plate, and to have said first ends of said selected magnetic members to be selectively seen through said plate.

2. The board as claimed in claim 1, wherein each of said first ends of said magnetic members is applied with a color thereon.

3. The board as claimed in claim 1, wherein each of said first ends of said magnetic members is applied with a pattern thereon.

4. The board as claimed in claim 1 further comprising a liquid received in said cavities of said board body respectively, to shield said magnetic members, and to prevent said first ends of said magnetic members from being seen through said plate when said magnetic members are retracted into and received in said cavities of said board body respectively, and to allow said one ends of said magnetic members to be seen through said plate when said magnetic members are attracted toward said plate.

5. The board as claimed in claim 1, wherein said magnetic members include a plurality of first magnetic members and a plurality of second magnetic members alternatively disposed in said cavities of said board body respectively.

6. The board as claimed in claim 5, wherein said first magnetic members and said second magnetic members include magnetic poles different from each other.

7. The board as claimed in claim 1 further comprising means for retaining said magnetic members deeply in said cavities of said board body respectively.

8. The board as claimed in claim 7, wherein said board body includes a plurality of orifices formed therein, said retaining means includes a plurality of magnetic elements slidably received in said orifices of said board body respectively, and actable with said magnetic members, to attract and to retain said magnetic members deeply in said cavities of said board body respectively.

9. The board as claimed in claim 8, wherein said board body includes a partition arranged between said orifices and said cavities thereof, to separate said orifices and said cavities thereof from each other.

10. The board as claimed in claim 8 further comprising means for biasing said magnetic elements away from said magnetic members respectively.

11. The board as claimed in claim 10, wherein said biasing means includes a plurality of springs received in said orifices of said board body respectively, and engaged with said magnetic elements respectively, to bias said magnetic elements away from said magnetic members respectively.

12. The board as claimed in claim 11, wherein each of said magnetic elements includes a shank extended therefrom, and said springs are engaged onto said shanks respectively.

13. The board as claimed in claim 8, wherein said magnetic elements includes a plurality of first magnetic elements and a plurality of second magnetic elements alternatively disposed in said orifices of said board body respectively.

14. The board as claimed in claim 13, wherein said first magnetic elements and said second magnetic elements include magnetic poles different from each other.

15. The board as claimed in claim 1, wherein said magnetic pen includes two ends each having a rounded surface formed thereon, to smoothly move on said plate, and to prevent said plate from being scraped by said magnetic pen.

16. The board as claimed in claim 1 further comprising a magnetic eraser to attract said magnetic members toward said plate.

17. The board as claimed in claim 1 further comprising a magnetic eraser to repel said magnetic members away from said plate.
